(19) United States
(12) Patent Application Publication
(10) Pub. No.: US 2016/0244012 A1
(43) Pub. Date: Aug. 25, 2016

(54) Extendable and Retractable Snowmobile Bumper

(71) Applicant: Jeannot Bilodeau, Invermere (CA)

(72) Inventor: Jeannot Bilodeau, Invermere (CA)

(21) Appl. No.: 14/630,856

(22) Filed: Feb. 25, 2015

(51) Int. Cl. B60R 19/40

(52) U.S. Cl. CPC B60R 19/40

(57) ABSTRACT

The present invention provides a system for providing an extendable and retractable snowmobile bumper having a connector mechanism constructed and arranged for connection to a snowmobile frame and further configured to receive an extension arm, an extension arm, a locking mechanism constructed and arranged for interaction with each of said connector arm and the connector mechanism imparting a selective configuration including an extended configuration and a retracted configuration of said extension arm.

### BACKGROUND OF THE INVENTION

While there are many accessories and devices that help promote snowmobile use and safety, there is one particular problem that has yet to be addressed. When a snowmobile gets stuck in a particular location, it is typically difficult to lift the snowmobile out of the area in which it is stuck. The present invention provides an extendable snowmobile bumper, whereby extending a solid, rigid member outward from the rear of the snowmobile, a person can utilize leverage to either pull up or push down the rear portion of the snowmobile in order to engage the treads and free the snowmobile from its stuck position.

### SUMMARY OF THE INVENTION

In one embodiment, the present invention is a system for providing an extendable and retractable snowmobile bumper, said system comprising: a connector mechanism constructed and arranged for connection to a snowmobile frame and further configured to receive an extension arm; an extension arm; a locking mechanism constructed and arranged for interaction with each of said connector arm and said connector mechanism; whereby said system imparts a selective configuration including an extended configuration and a retracted configuration of said extension arm.

In one embodiment, the connector mechanism configuration configured to receive an extension arm is on the rear of a snowmobile.

In one embodiment, the connector mechanism configuration configured to receive an extension arm is positioned between about 50 to 80% vertical height upward from the ground and relative to the height of the snowmobile. For example, if the snow machine is 60 cm from ground to top, the connector is positioned about the snowmobile at a vertical height from the ground between about 30-48 cm.

In one embodiment, the locking mechanism is a ball detent mechanism.

In one embodiment, the extension arm is formed of material of sufficient strength to support the weight of the snowmobile onto which said extension arm is attached. This varies depending on the snowmobile used. Snowmobiles can weigh between about 100-400 kg. The arm is intended to lift the snowmobile when the snowmobile is stuck and therefore must be able to support this weight.

In one embodiment, the connector mechanism is formed of material of sufficient strength to support the weight of the snowmobile onto which said extension arm is attached when said snowmobile is lifted by said connector arm.

### BRIEF DESCRIPTION OF THE SEVERAL VIEWS OF THE DRAWING

FIG. 1 is a side perspective view of a system of the present invention with the snowmobile bumper in the retracted position.

FIG. 2 is a side perspective view of the present invention with the snowmobile bumper in an extended position.

FIG. 3 is a top plan partial cross-section view of the snowmobile bumper assembly in a retracted position.

FIG. 4 is a side view of the snowmobile bumper assembly in a retracted position.

FIG. 5 is a top plan partial cross-section view of the snowmobile bumper in an extended position.

FIG. 6 is a side view of the snowmobile bumper assembly in an extended position.

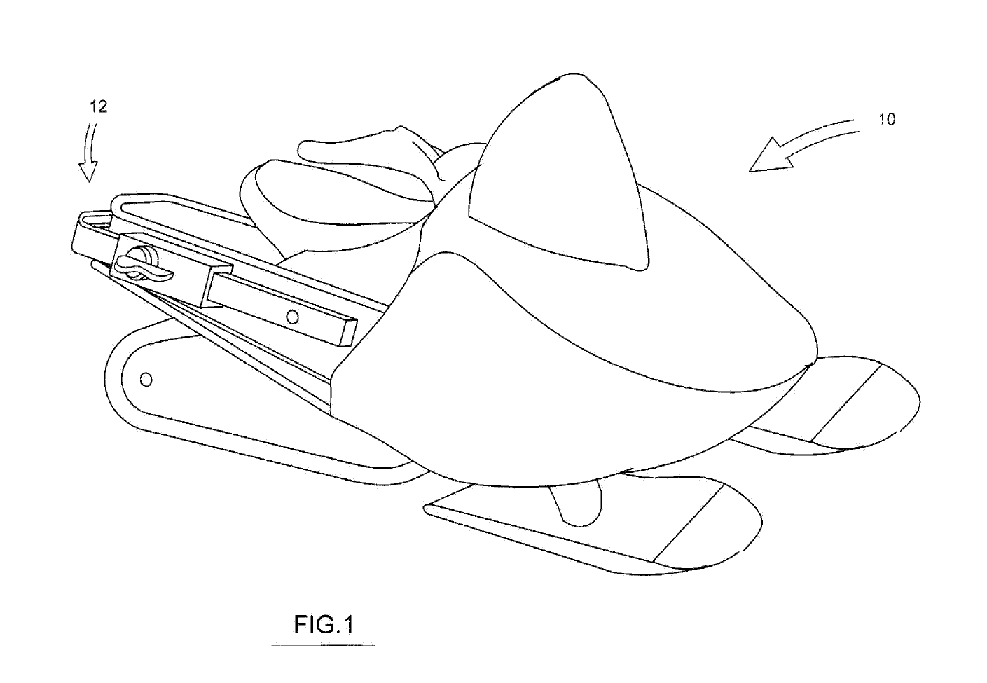

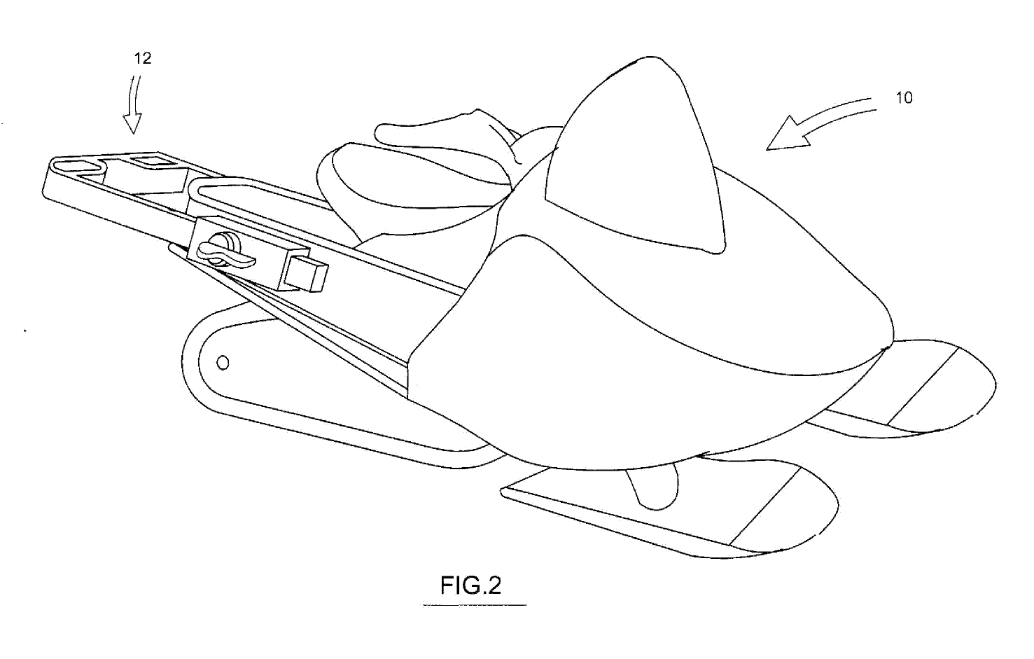

### DETAILED DESCRIPTION OF THE PREFERRED EMBODIMENT

As generally understood, the present invention relates to an extendable and retractable bumper system configured for use on a snowmobile. System 10 includes a bumper assembly 12. Bumper assembly 12 affixes to snowmobile frame 14 using bumper connector system 18. Extension arm 16 is locked into position, either extended or retracted as desired, utilizing lock pin system 20. Although the drawings demonstrate a particular lock pin system, the present invention contemplates that any particular mechanism that can lock extension arm 16 into a fixed, immovable position is contemplated as usable with the present invention.

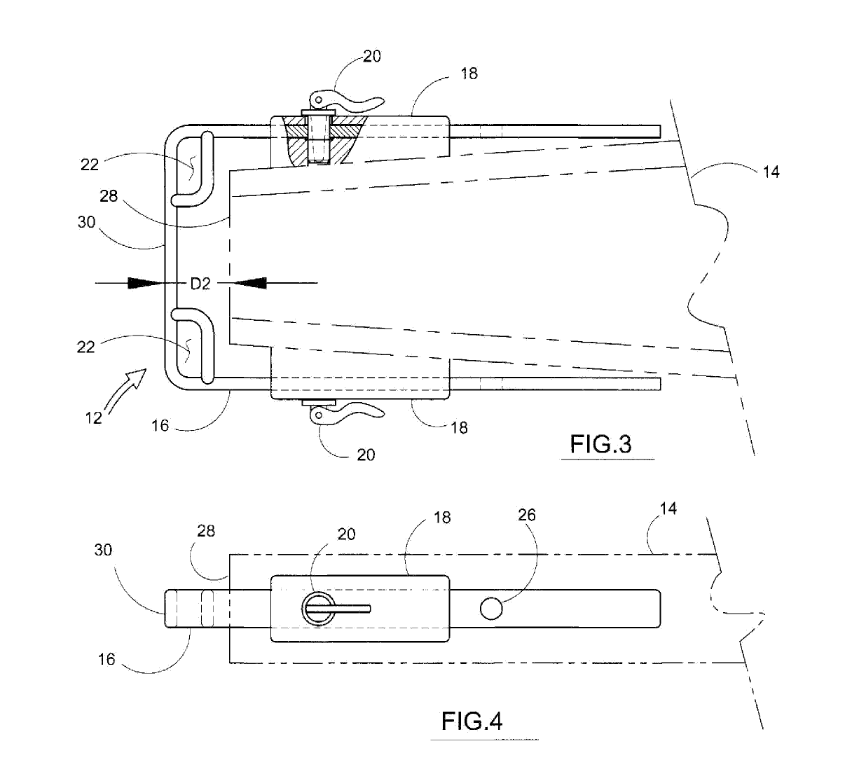

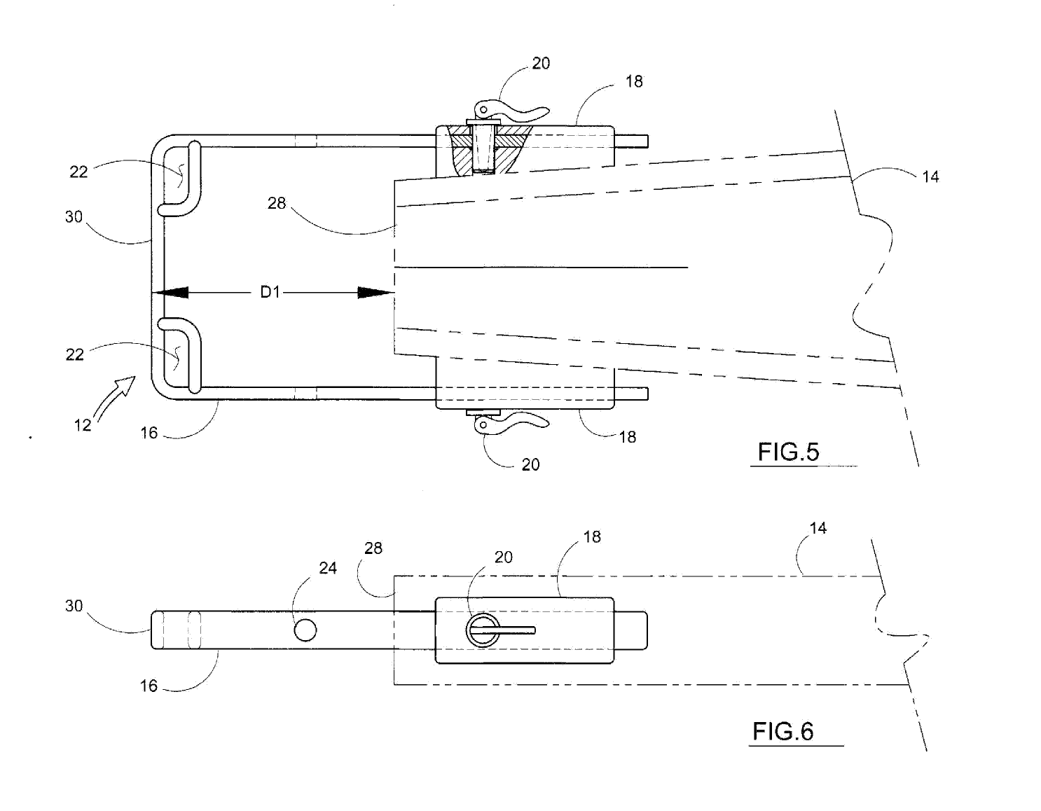

Extension arm 16 has formed on one proximal end one or more regions encompassing a cavity intended to be used as a hand or hook grasping structure. As generally understood, and demonstrated in FIG. 3, snowmobile frame 14 has a rear edge 28. In a retracted position, extension arm 16 is collapsed to a distance D2, representing the distance from the distal end of extension arm 16 to the back edge 28 of snowmobile frame 14. Extension arm 16 has formed on a distal end (distal referring to the end away from snowmobile frame 14) an end member 30 of extension arm 16.

In one embodiment, extension arm 16 has a plurality of locking cavities configured thereon, constructed and arranged to interact with locking pin mechanism 20. In one embodiment, as demonstrated in FIGS. 4 and 6, the user selectively engages extension locking cavity 26 or retracting locking cavity 24 as desired.

In use, it is contemplated that extension arm 16 be in a retracted position as demonstrated in FIGS. 3 and 4. In situations where it becomes necessary for external forces to be used in order to free a snowmobile that is having difficulty moving, such as a snowmobile that is stuck in a particular area of snow, each locking pin 20 is released. A user will grasp end portion 30 of extension arm 16, preferably at grasp 22, and use the extended configuration of extension arm 16 in system 10 in order to apply leverage for moving a snowmobile.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A system for providing an extendable and retractable snowmobile bumper, said system comprising: a connector mechanism constructed and arranged for connection to a snowmobile frame and further configured to receive an extension arm; an extension arm; a locking mechanism constructed and arranged for interaction with each of said connector arm and said connector mechanism; whereby said system imparts a selective configuration including an extended configuration and a retracted configuration of said extension arm.

2. The system of claim 1 wherein said connector mechanism configuration configured to receive an extension arm is on the rear of a snowmobile.

3. The system of claim 1 wherein said connector mechanism configuration configured to receive an extension arm is positioned between about 50 to 80% vertical height upward from the ground and relative to the height of the snowmobile.

4. The system of claim 1 wherein said locking mechanism is a ball detent mechanism.

5. The system of claim 1 wherein said extension arm is formed of material of sufficient strength to support the weight of the snowmobile onto which said extension arm is attached.

6. The system of claim 1 wherein said connector mechanism is formed of material of sufficient strength to support the weight of the snowmobile onto which said extension arm is attached when said snowmobile is lifted by said connector arm.
